(19) United States
(12) Patent Application Publication
(10) Pub. No.: US 2007/0064997 A1
(43) Pub. Date: Mar. 22, 2007

(54) Mask defect inspecting method, mask defect inspecting apparatus, and semiconductor device manufacturing method

(76) Inventor: Masamitsu Itoh, Yokohama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/521,305

(22) Filed: Sep. 15, 2006

(30) Foreign Application Priority Data
Sep. 16, 2005 (JP) 2005-270054

(51) Int. Cl. G06K 9/00

(52) U.S. Cl. 382/144

(57) ABSTRACT

According to an aspect of the invention, there is provided a mask defect inspecting method including setting, for a mask to be inspected, an optical defect inspection sensitivity for defect inspection using light, setting, for the mask to be inspected, an EB defect inspection sensitivity for defect inspection using electron beams, associating pattern data on the mask to be inspected with information on a required defect inspection sensitivity to create defect inspection data, inputting the defect inspection data and the optical defect inspection sensitivity to an optical defect inspecting apparatus to carry out defect inspection on an area corresponding to the pattern data associated with the optical defect inspection sensitivity, and inputting the defect inspection data and the EB defect inspection sensitivity to an EB defect inspecting apparatus to carry out defect inspection on an area corresponding to the pattern data associated with the EB defect inspection sensitivity.

### CROSS-REFERENCE TO RELATED APPLICATIONS

This application is based upon and claims the benefit of priority from prior Japanese Patent Application No. 2005-270054, filed Sep. 16, 2005, the entire contents of which are incorporated herein by reference.

### BACKGROUND OF THE INVENTION

1. Field of the Invention

The present invention relates to manufacture of an exposure mask, and in particular, to a mask defect inspecting method, a mask defect inspecting apparatus, and a semiconductor device manufacturing method.

2. Description of the Related Art

In recent years, a photolithography step of a semiconductor manufacturing process has had significant challenges. The decreasing sizes of semiconductor devices have resulted in a growing demand for micro-patterning in the photolithography step. The device design rule has already been reduced to 55 nm. Pattern sizes must be controlled to a very high accuracy of at most 5 nm.

This also applies to defect inspections for exposure masks, which have been requested to be very precise. Specifically, even a defect of size about 50 nm must be detected on an exposure mask. However, conventional optical defect inspecting apparatuses using light such as ultraviolet rays cannot offer a sufficient resolution to detect very small defects. Thus, to compensate for the insufficient resolution, the optical defect inspecting apparatus is used with an EB defect inspecting apparatus using electron beams offering a very high resolution.

However, the EB defect inspecting apparatus offers a very low inspection speed and requires a very long time to inspect the entire mask. Accordingly, a technique for efficiently inspecting only appropriate areas on the mask has been desired.

Jpn. Pat. Appln. KOKAI Publication No. 2002-244275 discloses a method of dividing an inspection area on a photo mask into at least two areas on the basis of the adverse effect of a defect on the photo mask on the operation of the device, and setting inspection sensitivity for each of the resulting inspection areas.

### BRIEF SUMMARY OF THE INVENTION

According to an aspect of the invention, there is provided a mask defect inspecting method comprising: setting, for a mask to be inspected, an optical defect inspection sensitivity for defect inspection using light; setting, for the mask to be inspected, an EB defect inspection sensitivity for defect inspection using electron beams; associating pattern data on the mask to be inspected with information on a required defect inspection sensitivity to create defect inspection data; inputting the defect inspection data and the optical defect inspection sensitivity to an optical defect inspecting apparatus to carry out defect inspection on an area corresponding to the pattern data associated with the optical defect inspection sensitivity; and inputting the defect inspection data and the EB defect inspection sensitivity to an EB defect inspecting apparatus to carry out defect inspection on an area corresponding to the pattern data associated with the EB defect inspection sensitivity.

According to another aspect of the invention, there is provided a mask defect inspecting apparatus which inspects a mask to be inspected for defects, the apparatus comprising: a defect inspection level setting section which sets a defect inspection level to be inspected; a defect inspection area selecting section which selects pattern data corresponding to the defect inspection level set by the defect inspection level setting section, from defect inspection data in which pattern data on the mask to be inspected is associated with the defect inspection level; and a defect inspecting section which carries out defect inspection on an area corresponding to the pattern data selected by the defect inspection area selecting section.

According to another aspect of the invention, there is provided a semiconductor device manufacturing method comprising: setting, for a mask to be inspected, an optical defect inspection sensitivity for defect inspection using light; setting, for the mask to be inspected, an EB defect inspection sensitivity for defect inspection using electron beams; associating pattern data on the mask to be inspected with information on a required defect inspection sensitivity to create defect inspection data; inputting the defect inspection data and the optical defect inspection sensitivity to an optical defect inspecting apparatus to carry out defect inspection on an area corresponding to the pattern data associated with the optical defect inspection sensitivity; inputting the defect inspection data and the EB defect inspection sensitivity to an EB defect inspecting apparatus to carry out defect inspection on an area corresponding to the pattern data associated with the EB defect inspection sensitivity; and manufacturing a semiconductor device using the mask to be inspected in which any defected defect has been corrected.

### BRIEF DESCRIPTION OF THE SEVERAL VIEWS OF THE DRAWING

FIG. 1 is a flowchart showing a process of manufacturing an exposure mask according to a first embodiment;

FIG. 2 is a block diagram showing the general configuration of an optical defect inspecting apparatus and an EB defect inspecting apparatus according to the first embodiment;

FIG. 3 is a diagram showing defect inspection areas covered by the optical defect inspecting apparatus and EB defect inspecting apparatus; and

FIG. 4 is a flowchart showing an exposure mask manufacturing process according to a second embodiment.

### DETAILED DESCRIPTION OF THE INVENTION

Embodiments of the present invention will be described with reference to the drawings.

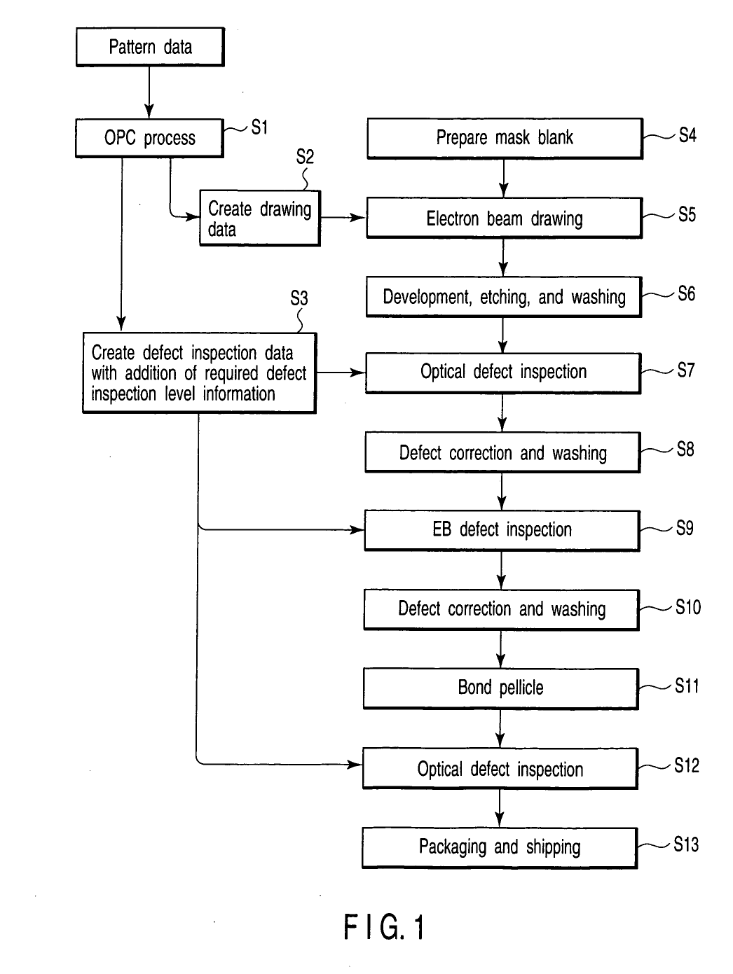

FIG. 1 is a flowchart showing a process of manufacturing an exposure mask according to a first embodiment. The exposure mask manufacturing process will be described with reference to FIG. 1.

First, in step S1, design data on a device pattern is OPC (Optical Proximity Effect Correction) processed. In step S2, drawing data is created, and in step S3, defect inspection data is created and stored in a storage section; the defect inspection data is composed of the OPC processed design data with the addition of required defect inspection level information.

The required defect inspection level information is provided by a device designer on the basis of the adverse effect of a defect on an exposure mask (subject mask, mask to be inspected) on the device pattern. Different required defect inspection levels are set for the respective positions on the pattern. More specifically, pattern data is divided into data sets for the respective areas on the exposure mask which involve different defect inspection levels. Required clear defect inspection levels and opaque defect inspection levels are set for the respective divided area. A clear defect means a defect in which a shielding section is not present where it should be. A opaque defect means a defect in which a shielding member is present in a light transmitting section.

In step S4, an ArF halftone (HT) blank is prepared on which an electron beam resist is coated. In step S5, an electron beam mask drawing apparatus (EBM5000 manufactured by NuFlare Technology, Inc.) is used to draw a device pattern at the 55-nm technology node on the blank on the basis of the drawing data created in step S2. The device pattern area is about 10,000 mm² on the exposure mask.

In step S6, a baking process (PEB) is executed and alkali development is executed to develop a resist pattern, as is the case with a normal exposure mask manufacturing process. The resist pattern is subsequently used as an etching mask to dry etch a Cr film and an HT film. An oxygen plasma process is subsequently executed to strip the resist, and a wet washer is used to wash the mask.

In step S7, the washed mask is inspected for defects using an optical defect inspecting apparatus (MC3500 manufactured by TOSHIBA MACHINE CO., LTD.). This defect inspection is what is called a die-to-database comparative inspecting method in which an inspection target exposure mask set in the optical defect inspecting apparatus is compared with the defect inspection data with the addition of the required defect inspection level information. Light used for the inspection has a wavelength of 255 nm.

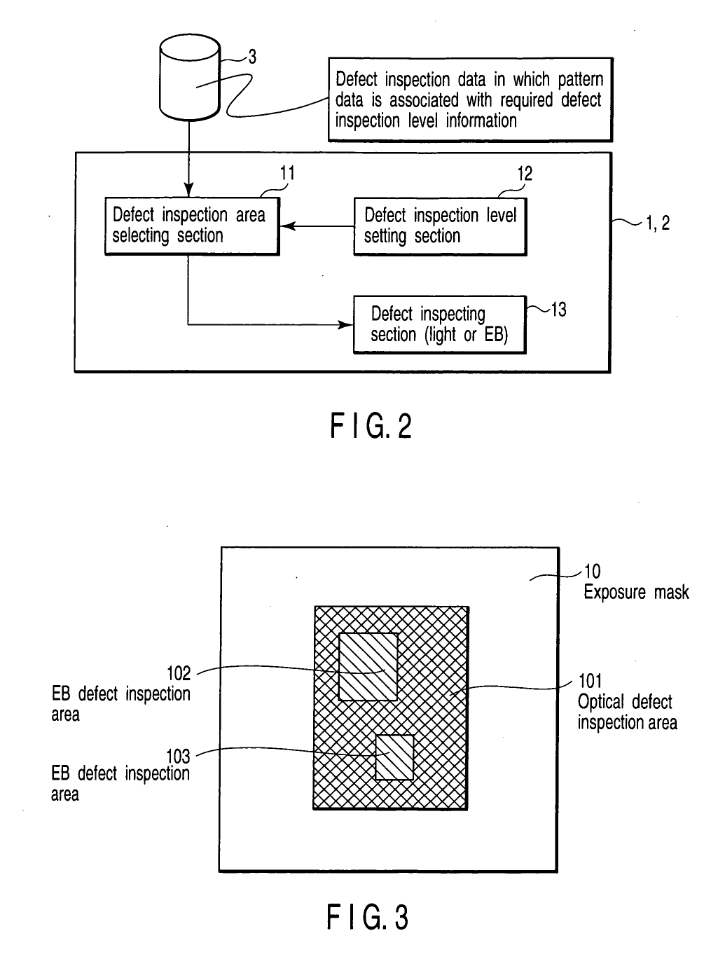

FIG. 2 is a block diagram showing the general configuration of the optical defect inspecting apparatus and EB defect inspecting apparatus. The optical defect inspecting apparatus 1 (or EB defect inspecting apparatus 2) has a function for selectively inspecting, on the basis of the required defect inspection level information, those areas on the exposure mask which involve preset optical defect inspection levels (or EB defect inspection levels) to be inspected using the optical defect inspecting apparatus 1 (or EB defect inspecting apparatus 2).

A defect inspection area selecting section 11 reads in the required defect inspection level information on an area to be inspected before reading in pattern data from the defect inspection data in the storage section 3. Only if the value for that required defect inspection level information corresponds to the optical (EB) defect inspection levels to be inspected which are preset in a defect inspection level setting section 12, the defect inspection area selecting section 11 selectively reads in pattern data from the defect inspection data 3 and sends it to a defect inspecting section 13.

On the basis of the sent pattern data, the defect inspecting section 13 carries out defect inspection on that area on the exposure mask which corresponds to the pattern data. Specifically, the defect inspection is carried out by loading and comparing an image of the pattern formed in the exposure mask with the pattern data or comparison data obtained from the pattern data.

In the first embodiment, the defect inspection level setting section 12 of the optical defect inspecting apparatus set optical defect inspection levels (optical defect inspection sensitivities) shown in Table 1. The optical defect inspecting apparatus inspects areas involving required defect inspection levels corresponding to defect sizes of at least 90 nm for a clear defect and at least 70 nm for a opaque defect.

TABLE 1

| | Optical defect | EB defect |
|---|---|---|
| | inspection level | inspection level |
| clear defect | At least 90 nm | At most 100 nm |
| inspection | | |
| level | | |
| opaque defect | At least 70 nm | At most 100 nm |
| inspection | | |
| level | | |

As shown in FIG. 3, with the exposure mask 10, an optical defect inspection area 101 was about 9,000 mm². The optical defect inspecting apparatus had an inspection speed of about 2,000 mm²/h and required about 4 or 5 hours for inspection.

After the optical defect inspecting apparatus finishes the inspection, in step S8, any detected defect is corrected by a defect correcting apparatus. The exposure mask is then washed again using the washer.

In step S9, the washed mask is inspected for defects using the EB defect inspecting apparatus. This defect inspection is also what is called the die-to-database comparative inspecting method in which an inspection target exposure mask set in the EB defect inspecting apparatus is compared with the defect inspection data with the addition of the required defect inspection level information. In place of light, electron beams are used for the inspection. An acceleration voltage for the electron beams is 1,500 V.

As shown in FIG. 2, like the above optical defect inspecting apparatus 1, the EB defect inspecting apparatus 2 has a function for selectively inspecting, on the basis of the required defect inspection level information, those areas on the exposure mask which involve preset EB defect inspection levels to be inspected using the EB defect inspecting apparatus 2. The EB defect inspection levels are set by, when exposing and transferring a pattern formed on the exposure mask to a semiconductor wafer, estimating, through simulation, margins of an exposure amount and a focal position required to achieve the transfer so that the resulting pattern has desired dimensions, and determining a pattern area for which both margins have predetermined values or smaller to be involved in an inspection area.

The defect inspection area selecting section 11 reads in the required defect inspection level information on an area to be inspected before reading in pattern data from the defect inspection data in the storage section 3. Only if the value for that required defect inspection level information corresponds to the EB defect inspection levels preset in a defect inspection level setting section 12, the defect inspection area selecting area 11 selectively reads in pattern data from the defect inspection data 3 and sends it to the defect inspecting section 13. On the basis of the sent pattern data, the defect inspecting section 13 carries out defect inspection on that area on the exposure mask which corresponds to the pattern data.

In the first embodiment, the defect inspection level setting section 12 of the EB defect inspecting apparatus set EB defect inspection levels (EB defect inspection sensitivities) shown in Table 1. The EB defect inspecting apparatus inspects areas involving EB defect inspection levels corresponding to defect sizes of at most 100 nm for a clear defect and at most 100 nm for a opaque defect.

As shown in FIG. 3, with the exposure mask 10, EB defect inspection areas 102 and 103 were about 2,000 mm² in total. The EB defect inspecting apparatus had an inspection speed of about 400 mm²/h and required about 5 hours for inspection. In contrast, the prior art inspects the entire pattern area and thus requires as long as 25 hours.

After the EB defect inspecting apparatus finishes the inspection, in step S10, any detected defect is corrected by the defect correcting apparatus. The exposure mask is then washed again using the washer. Subsequently, in step S11, a pelicle is bonded to the exposure mask. In step S12, defect inspection is carried out again using the optical defect inspecting apparatus.

Similarly to the above inspection, this defect inspection uses the defect inspection data with the addition of required defect inspection level information. However, the defect inspection levels preset in the defect inspection level setting section 12 of the optical defect inspecting apparatus are set at values intended to inspect all the areas on the exposure mask. This defect inspection is carried out after the pelicle has been bonded, and cannot be achieved using electron beams. The optical defect inspecting apparatus is thus used to inspect areas that must originally be inspected using electron beams.

Finally, in step S13, the exposure mask is packaged and shipped. The exposure mask and a wafer exposure apparatus are subsequently used to expose a semiconductor wafer from which a semiconductor device is finally manufactured.

According to the first embodiment, the optical defect inspecting apparatus carries out defect inspection on those areas on the exposure mask which involve a lower defect inspection level (larger defect size). The EB defect inspecting apparatus carries out defect inspection only on those areas on the exposure mask which involve a higher defect inspection level (smaller defect size). Thus, the first embodiment automatically carries out efficient defect inspections. This makes it possible to sharply reduce the mask defect inspection time, which is conventionally disadvantageously long, thus significantly reducing the time and cost required to manufacture a mask. This in turn makes it possible to reduce the cost and delivery time of a semiconductor device manufactured using this mask.

The conventional EB defect inspection enables a certain area to be restrictively inspected. However, this is possible only if the area to be subjected to EB defect inspection has a certain size and can also be expressed as a simple shape. However, in many actual masks, the area to be subjected to EB defect inspection is divided into very small complicated shapes. With the conventional EB defect inspection, a large, simply shaped inspection area can be obtained by making setting such that even somewhat larger defects are inspected. However, this requires a very long inspection time, thus increasing costs.

The present embodiment enables the minimum area to be subjected to EB defect inspection to be automatically inspected. This allows precise defect inspections to be carried in the minimum time, greatly contributing to reducing the mask manufacture costs.

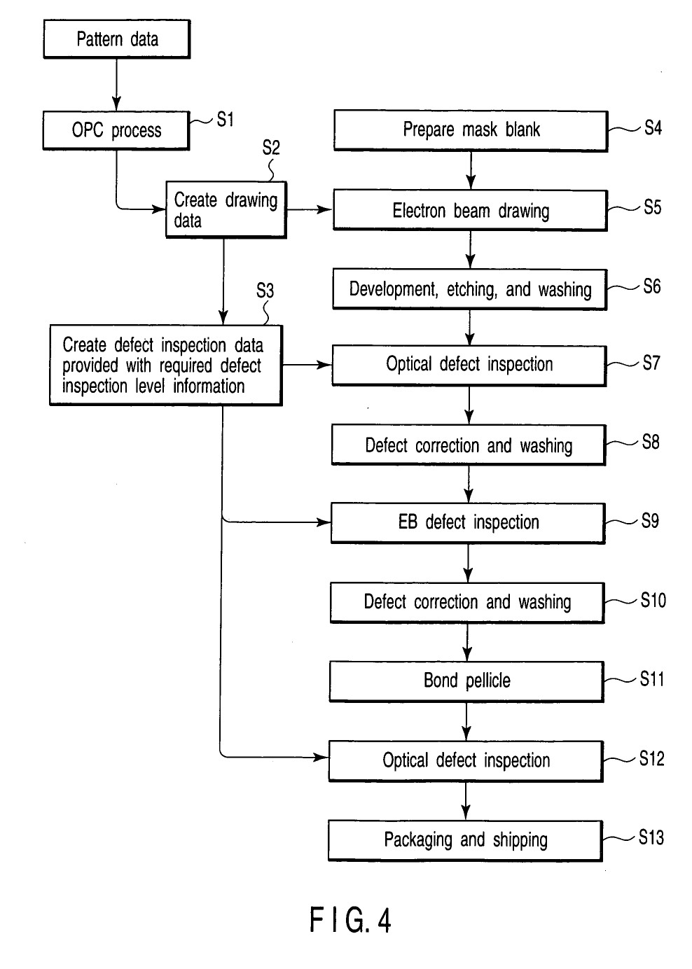

FIG. 4 is a flowchart showing an exposure mask manufacturing process according to a second embodiment. In FIG. 4, the same components as those in FIG. 1 are denoted by the same reference numerals.

According to the first embodiment, in step S1, design data on a device pattern is OPC processed. In step S2, drawing data is created, and in step S3, defect inspection data is created and stored in the storage section; the defect inspection data is composed of the OPC processed design data with the addition of required defect inspection level information.

In contrast, according to the second embodiment, in step S1, design data on a device pattern is OPC processed. In step S2, drawing data is created, and in step S3, defect inspection data with the addition of required defect inspection level information is created. The remaining part of the procedure is the same as that in the first embodiment.

Also according to the second embodiment, the optical defect inspecting apparatus carries out defect inspection on those areas on the exposure mask which involve a lower defect inspection level (larger defect size). The EB defect inspecting apparatus carries out defect inspection only on those areas on the exposure mask which involve a higher defect inspection level (smaller defect size). Thus, the second embodiment automatically carries out efficient defect inspections. This makes it possible to sharply reduce the mask defect inspection time, which is conventionally disadvantageously long, thus significantly reducing the time and cost required to manufacture a mask.

In the above embodiments, the defect inspection levels are represented as numerical values. However, instead of the numerical values, the defect inspection levels may be represented as symbols such as A, B, . . . for each of which a defect size range may be set. Naturally, the mask manufacturing process can involve not only the defect inspection but also the measurement of mask pattern dimensions, phase, or transmittance as required. Further, in the above embodiments, the EB defect inspection (S9) follows the optical defect inspection (S7). However, the optical defect inspection may follow the EB defect inspection.

The above embodiments use an ArF photo mask. However, the manufacturing processes in the above embodiments are also applicable to EUV lithography photo masks.

The present embodiments provide a mask defect inspecting method, a mask defect inspecting apparatus, and a semiconductor device manufacturing method which make it possible to automatically inspect the minimum area on a mask to be subjected to EB defect inspection, thus enabling precise defect inspections to be achieved in the minimum time.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A mask defect inspecting method comprising:
setting, for a mask to be inspected, an optical defect inspection sensitivity for defect inspection using light;
setting, for the mask to be inspected, an EB defect inspection sensitivity for defect inspection using electron beams;
associating pattern data on the mask to be inspected with information on a required defect inspection sensitivity to create defect inspection data;
inputting the defect inspection data and the optical defect inspection sensitivity to an optical defect inspecting apparatus to carry out defect inspection on an area corresponding to the pattern data associated with the optical defect inspection sensitivity; and
inputting the defect inspection data and the EB defect inspection sensitivity to an EB defect inspecting apparatus to carry out defect inspection on an area corresponding to the pattern data associated with the EB defect inspection sensitivity.

2. The mask defect inspecting method according to claim 1, further comprising:
when exposing and transferring a pattern formed in the mask to be inspected, estimating, through simulation, margins of an exposure amount and a focal position which are required to achieve the transfer so that a resulting pattern has desired dimensions; and
setting the EB defect inspection sensitivity for a pattern area for which the margins have predetermined values or smaller.

3. The mask defect inspecting method according to claim 1, wherein the defect inspection using the optical defect inspecting apparatus and the EB defect inspecting apparatus is carried out by a die-to-database comparative inspection method.

4. The mask defect inspecting method according to claim 1, wherein the EB defect inspection sensitivity is higher than the optical defect inspection sensitivity.

5. The mask defect inspecting method according to claim 1, wherein the optical defect inspection sensitivity and the EB defect inspection sensitivity are intended for a clear defect and a opaque defect.

6. The mask defect inspecting method according to claim 1, wherein the optical defect inspection sensitivity and the EB defect inspection sensitivity are represented as defect sizes.

7. The mask defect inspecting method according to claim 1, wherein after defect inspection using the optical defect inspecting apparatus and defect inspection using the EB defect inspecting apparatus, defect inspection using the optical defect inspecting apparatus is carried out again.

8. The mask defect inspecting method according to claim 1, wherein after drawing data is created on the basis of the pattern data, the defect inspection data is created from the drawing data.

9. The mask defect inspecting method according to claim 1, wherein the mask to be inspected is an ArF photo mask.

10. The mask defect inspecting method according to claim 1, wherein the mask to be inspected is an EUV lithography photo mask.

11. A mask defect inspecting apparatus which inspects a mask to be inspected for defects, the apparatus comprising:
a defect inspection level setting section which sets a defect inspection level to be inspected;
a defect inspection area selecting section which selects pattern data corresponding to the defect inspection level set by the defect inspection level setting section, from defect inspection data in which pattern data on the mask to be inspected is associated with the defect inspection level; and
a defect inspecting section which carries out defect inspection on an area corresponding to the pattern data selected by the defect inspection area selecting section.

12. The mask defect inspecting apparatus according to claim 11, wherein the defect inspection is an optical defect inspection or an EB defect inspection.

13. The mask defect inspecting apparatus according to claim 11, wherein the defect inspection is carried out by a die-to-database comparative inspection method.

14. The mask defect inspecting apparatus according to claim 12, wherein the EB defect inspection level is higher than the optical defect inspection level.

15. The mask defect inspecting apparatus according to claim 11, wherein the defect inspection levels are intended for a clear defect and a opaque defect.

16. The mask defect inspecting apparatus according to claim 11, wherein the defect inspection levels are represented as defect sizes.

17. A semiconductor device manufacturing method comprising:
setting, for a mask to be inspected, an optical defect inspection sensitivity for defect inspection using light;
setting, for the mask to be inspected, an EB defect inspection sensitivity for defect inspection using electron beams;
associating pattern data on the mask to be inspected with information on a required defect inspection sensitivity to create defect inspection data;
inputting the defect inspection data and the optical defect inspection sensitivity to an optical defect inspecting apparatus to carry out defect inspection on an area corresponding to the pattern data associated with the optical defect inspection sensitivity;
inputting the defect inspection data and the EB defect inspection sensitivity to an EB defect inspecting apparatus to carry out defect inspection on an area corresponding to the pattern data associated with the EB defect inspection sensitivity; and
manufacturing a semiconductor device using the mask to be inspected in which any defected defect has been corrected.

18. The semiconductor device manufacturing method according to claim 17, further comprising:
when exposing and transferring a pattern formed in the mask to be inspected, estimating, through simulation, margins of an exposure amount and a focal position which are required to achieve the transfer so that a resulting pattern has desired dimensions; and
setting the EB defect inspection sensitivity for a pattern area for which the margins have predetermined values or smaller.
